(19) United States
(12) Patent Application Publication
(10) Pub. No.: US 2015/0123328 A1
(43) Pub. Date: May 7, 2015

(54) TORSION BAR PACK AND ASSEMBLIES

(71) Applicants: Todd Michael Whitaker, Boulder, CO (US); Adam Cuthbert Pauluhn, Niwot, CO (US)

(72) Inventors: Todd Michael Whitaker, Boulder, CO (US); Adam Cuthbert Pauluhn, Niwot, CO (US)

(21) Appl. No.: 14/532,413

(22) Filed: Nov. 4, 2014

Related U.S. Application Data
(60) Provisional application No. 61/899,363, filed on Nov. 4, 2013.

(51) Int. Cl. F16F 1/14

(52) U.S. Cl. CPC F16F 1/14
USPC 267/154

(57) ABSTRACT

A torsion bar pack including a plurality of torsion bars, each torsion bar including at least an elongated inner tube of flexible material having a proximal end and a distal end, an elongated outer tube of flexible material having a proximal end and a distal end, and a joiner bushing fixedly attached to the distal end of the inner tube and to the distal end of the outer tube with the inner tube and outer tube positioned in coaxial and concentric nesting positions, and input/output apparatus connected at the proximal ends. Two or more of the torsion bars connected in one of a torsion bar pack parallel connection or a torsion bar pack series connection and the torsion bar pack parallel connection or the torsion bar pack series connection including the input/output apparatus.

### CROSS-REFERENCE TO RELATED APPLICATIONS

This application claims the benefit of U.S. Provisional Patent Application No. 61/899,363, filed 4 Nov. 2014.

### FIELD OF THE INVENTION

This invention generally relates to torsion bar type springs and more specifically to packs of torsion bars connected in parallel and/or series and torsion bar packs interconnected into torsion bar assemblies.

### BACKGROUND OF THE INVENTION

Many types of springs are available for energy storage. For example, coil springs store energy by compressing a helically wound wire. Other types of conventional springs include torsion springs and torsion bars. All spring systems can be characterized by how much energy can be stored per unit volume. Another property by which springs can be characterized is by how much energy can be stored per unit mass (or weight). The performance of devices which utilize springs for energy storage are improved through utilization of a torsion bar type spring, such as disclosed in U.S. Pat. No. 8,505,888, entitled “Tubular Torsion Bar”, issued Aug. 13, 2013, by increasing the amount of energy which can be stored per unit volume and per unit mass. The performance of devices which utilize springs for energy storage can be further improved through use of the torsion bar pack of the present invention.

The present invention is a modification of the torsion bar type spring disclosed in U.S. Pat. No. 8,505,888. The tubular torsion bar in the patent includes an elongated inner tube of flexible material having a proximal end and a distal end, an elongated outer tube of flexible material having a proximal end and a distal end, a joiner bushing fixedly attached to the distal end of the inner tube and to the distal end of the outer tube with the inner tube and outer tube positioned in coaxial and substantially coextensive concentric nesting positions, mounting apparatus fixedly attached to the proximal end of the outer tube, and output apparatus fixedly attached to the proximal end of the inner tube.

Accordingly, it is an object of the present invention to provide a new and improved torsion bar pack.

It is another object of the present invention to provide a new and improved torsion bar pack with improved energy storage potential per unit mass and volume.

It is another object of the present invention to provide a new and improved torsion bar pack that increases the angular deflection while maintaining the same maximum torque as an individual spring.

It is another object of the present invention to provide a new and improved torsion bar pack that increases the maximum torque while maintaining the same angular deflection as an individual spring.

It is another object of the present invention to provide a new and improved torsion bar assembly that is simple to manufacture and use.

### SUMMARY OF THE INVENTION

Briefly, to achieve the desired objects of the instant invention in accordance with a preferred embodiment a torsion bar pack is provided. The torsion bar pack includes a plurality of torsion bars, each torsion bar including at least an elongated inner tube of flexible material having a proximal end and a distal end, an elongated outer tube of flexible material having a proximal end and a distal end, and a joiner bushing fixedly attached to the distal end of the inner tube and to the distal end of the outer tube with the inner tube and outer tube positioned in coaxial and concentric nesting positions. Two or more of the torsion bars are connected in one of a torsion bar pack parallel connection or a torsion bar pack series connection.

In a specific embodiment, the two or more torsion bars of the plurality of torsion bars are connected at the proximal ends in one of the torsion bar pack parallel connection or the torsion bar pack series connection and the torsion bar pack parallel connection or the torsion bar pack series connection includes input/output apparatus coupled to the proximal ends of the two or more torsion bars.

Briefly, to achieve the desired objects of the instant invention in accordance with a preferred embodiment a new and improved torsion bar assembly is provided that includes a plurality of torsion bars, each torsion bar of the plurality of torsion bars including at least an elongated inner tube of flexible material having a proximal end and a distal end, an elongated outer tube of flexible material having a proximal end and a distal end, and a joiner bushing fixedly attached to the distal end of the inner tube and to the distal end of the outer tube with the inner tube and outer tube positioned in coaxial and concentric nesting positions. A common elongated mounting element mounts one end of each of the plurality of torsion bars in one of a torsion bar pack parallel connection or a torsion bar pack series connection so that the torsion bars of each of the plurality of torsion bars extend in a common direction, parallel and spaced apart along the length of the common elongated mounting element. Each of the plurality of torsion bars has input and output gears coupled therein with gears of adjacent torsion bars meshed together so that the input of each torsion bar pack along the elongated mounting element is connected to the output of the adjacent torsion bar pack, except for end packs.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a cross-sectional view in perspective of the tubular torsion bar disclosed in the above cited U.S. patent;

FIG. 2 is a perspective view of a torsion bar pack in accordance with the present invention, including a pair of tubular torsion bars connected in parallel;

FIG. 3 is a perspective view of another torsion bar pack in accordance with the present invention, including a pair of tubular torsion bars connected in series;

FIG. 4 is a side view of another torsion bar pack in accordance with the present invention, including a plurality of pairs of torsion bars connected in series; and

FIGS. 5 and 6 are side views of the torsion bar pack illustrated in FIG. 4 showing different possible torque inputs and outputs.

### DETAILED DESCRIPTION OF THE DRAWINGS

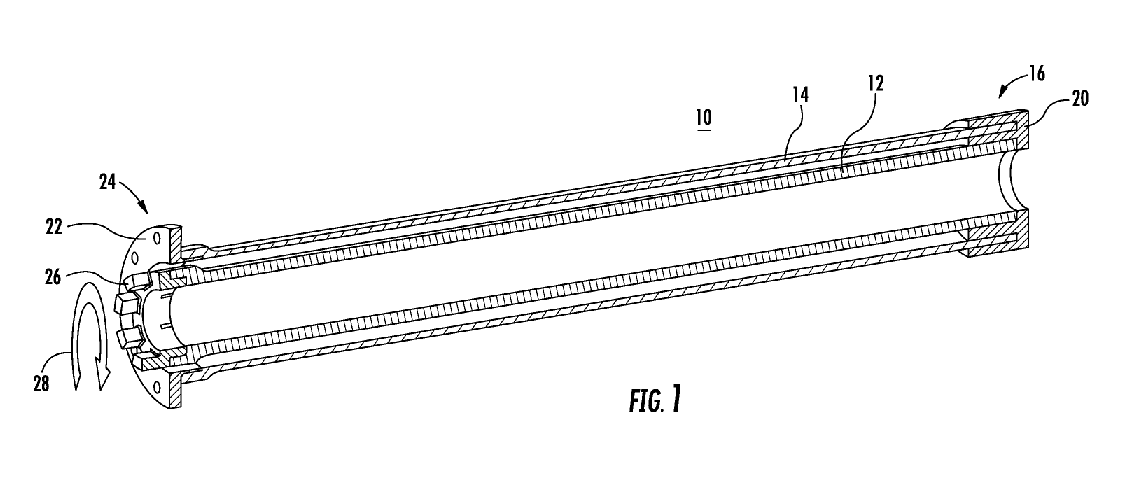

Turning now to FIG. 1, the tubular torsion bar 10 disclosed in the above cited U.S. patent is illustrated in cross-section. Torsion bar 10 includes an inner tube 12 and an axially aligned outer tube 14 fixedly joined at a distal end 16 by a joiner bushing 20. Joiner bushing 20, which is bonded to inner tube 12 and outer tube 14, is used to join inner tube 12 and outer tube 14 at distal end 16. As torsion bar 10 is loaded in torsion, joiner bushing 20 transmits torque between inner tube 12 and outer tube 14.

Mounting apparatus, which in this example includes a mounting ferrule 22, is attached to a proximate end 24 of outer tube 14 for fixedly attaching tubular torsion bar 10 to a component of a device (not shown) requiring some spring action. Output apparatus, which in this example includes an output ferrule 26, is attached to the proximate end of inner tube 12 and is designed to be coupled to a second component of the device. Here it should be noted that the term “output apparatus” is used to denote apparatus that not only provides an output torque but that also is used to apply input torque to tubular torsion bar 10. Also, in some special applications the mounting and output apparatus could be reversed.

Torsional or spring energy is stored in torsion bar 10 by rotating inner tube 12 relative to outer tube 14 that is by rotating output ferrule 26 as illustrated by arrow 28. Also, it will be understood that the torsional or spring energy stored in torsion bar 10 is applied to output ferrule 26. Generally, torsion bars utilized in the present invention may include any or all of the components, characteristics, materials and/or structure of torsion bar 10 as disclosed in the above identified U.S. patent.

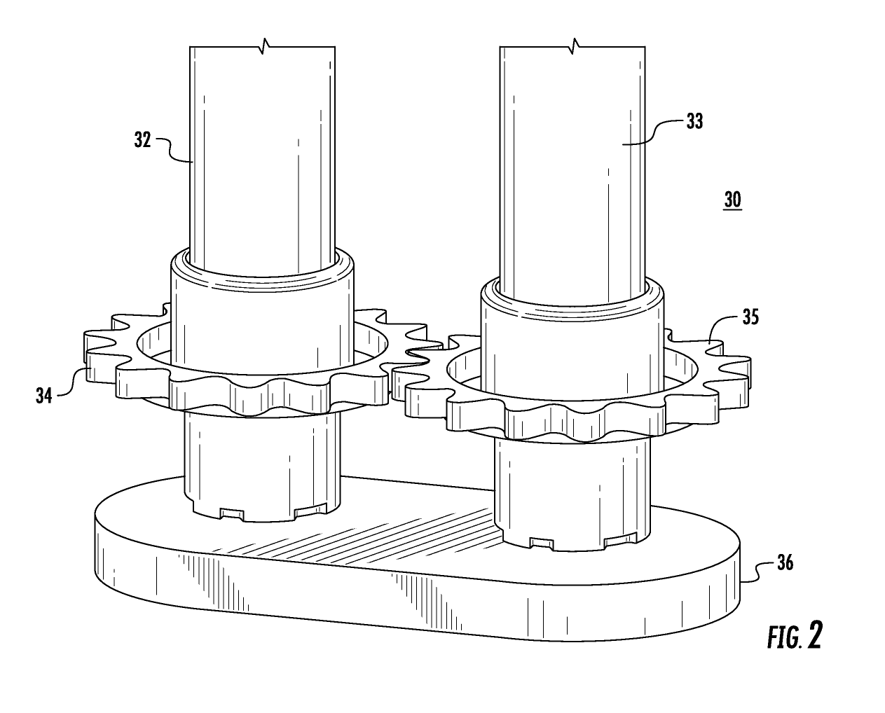

Referring now to FIG. 2, two tubular torsion bars, each generally similar to the above described torsion bar 10 and designated 32 and 33, are connected in parallel in a torsion bar pack 30 in accordance with the present invention. In torsion bar pack 30 the mounting ferrule 22 (see FIG. 1) for each torsion bar 32 and 33 is replaced with a gear 34 and 35, respectively. Also, the lower end of the inner tube (or output ferrule 26 in FIG. 1) for each torsion bar 34 and 35 is fixed by a common mounting element or base 36 with torsion bars 32 and 33 positioned in parallel and adjacent so that gears 34 and 35 are meshed together. Thus, the two torsion bars 32 and 33 are connected in parallel and an input torque applied to gear 34 is mirrored in gear 35 so that equal torque is applied to each torsion bar 32 and 33. Therefore, the maximum torque in this example with torsion bars 32 and 33 substantially similar is doubled, with each torsion bar 32 and 33 receiving approximately one half of the total input torque, while the angular deflection remains the same as for a single torsion bar. Output can be received at gear 35 or it can be taken from gear 34, depending upon the specific application. It will be understood that while a specific type of gear and a complete circular gear is illustrated any type of gear or gear-like device that will produce the required rotation can be used and in many applications the entire circular gear is not required, since the rotary movement of the inner and outer tubes is limited. The term “gear” is intended to include all such variations.

While the present description describes a torsion bar as including two parallel nested tubes it will be understood that the inner tube can in fact have an inner diameter at or approaching zero, i.e., a bar or rod, all of which are included in the term “Inner tube”. It should also be understood that while two torsion bars are illustrated and described in this example, as many additional torsion bars can be connected in parallel in a similar fashion as needed to fulfill any storage capacity required. Further, while torque is applied to the outer tube and the inner tube is fixed to base 36 in this example, it will of course be understood that base 36 could be fixed to the outer tube and torque could be applied to the inner tube. As an example (not illustrated), the outer tubes of each torsion bar 32 and 33 could be fixedly mounted by common mounting element or base 36 and the inner tubes could extend through an opening through common mounting element or base 36 and gears could be attached to the outwardly extending ends of the inner tubes.

Referring now to FIG. 3, a pair of tubular torsion bars, each generally similar to the above described torsion bar 10 and designated 42 and 43, is connected in series in a torsion bar pack 40 in accordance with the present invention. In torsion bar pack 40 the mounting ferrule 22 (see FIG. 1) for each torsion bar 42 and 43 is replaced with a gear 44 and 45. The lower end of the inner tube (output ferrule 26 in FIG. 1) for each torsion bar 42 and 43 is mounted for full floating movement by a bearing in a common mounting element or base 46 with torsion bars 42 and 43 positioned in parallel and adjacent but space apart sufficiently so that gears 44 and 45 are not meshed together. Also, an interconnection element 48, such as a belt or a chain, couples rotation of the inner tube of torsion bar 42 to the inner tube of torsion bar 43. Thus, the two torsion bars 42 and 43 are connected in series and an input torque can be applied to gear 44 with an output received at gear 45. Therefore, the maximum torque that can be applied to torsion bar pack 40 in this example is the same as a single torsion bar, while the angular deflection is approximately double that for a single torsion bar.

As explained above with reference to the parallel connected torsion bars, in the series connected torsion bars, as an example (not illustrated), the outer tubes of each torsion bar 42 and 43 could be mounted for full floating movement by bearings in a common mounting element or base 46 and the inner tubes could extend through an opening through common mounting element or base 46 and an interconnection element 48 could be attached to the outwardly extending ends of the inner tubes similar to the example illustrated in FIG. 3.

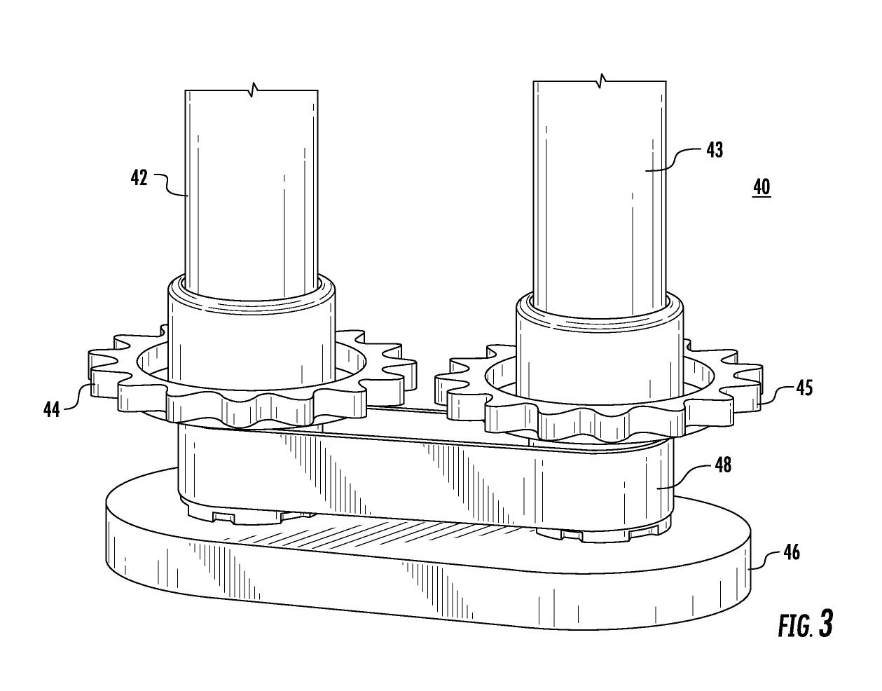

Turning now to FIG. 4, a plurality of torsion bar packs 40 are connected in series in a torsion bar assembly 50. Assembly 50 includes a first plurality 52 of torsion bar packs 40 with the base 46 of each pack 40 fixedly mounted on a common elongated mounting element 54 so that the torsion bars 42 and 43 of each pack 40 extend upwardly (in FIG. 4) and packs 40 are parallel and spaced apart along the length of elongated mounting element 54. Also, gears 44 or 45 mesh with gears 45 or 44 of adjacent packs 40 so that the input of each pack 40 (except the first and last) along elongated mounting element 54 is connected to the output of the adjacent pack 40.

In this specific example, assembly 50 includes a second plurality 56 of torsion bar packs 40 with the base 46 of each pack 40 fixedly mounted on a common elongated mounting element 58 so that the torsion bars 42 and 43 of each pack 40 extend downwardly (in FIG. 4) and packs 40 are parallel and spaced apart along the length of elongated mounting element 58. Also, gears 44 or 45 mesh with gears 45 or 44 of adjacent packs 40 so that the input of each pack 40 (except the first and last) along elongated mounting element 58 is connected to the output of the adjacent pack 40. Further, in this specific example, torsion bars 42 and 43 of first plurality 52 are interleaved with torsion bars 42 and 43 of second plurality 56 so that adjacent torsion bars are associated with the opposite plurality. Thus, all of torsion bars 42 and 43 in first plurality 52 are connected in series and all of torsion bars 42 and 43 in second plurality 56 are connected in series and the two pluralities are mounted to achieve a minimum of required space.

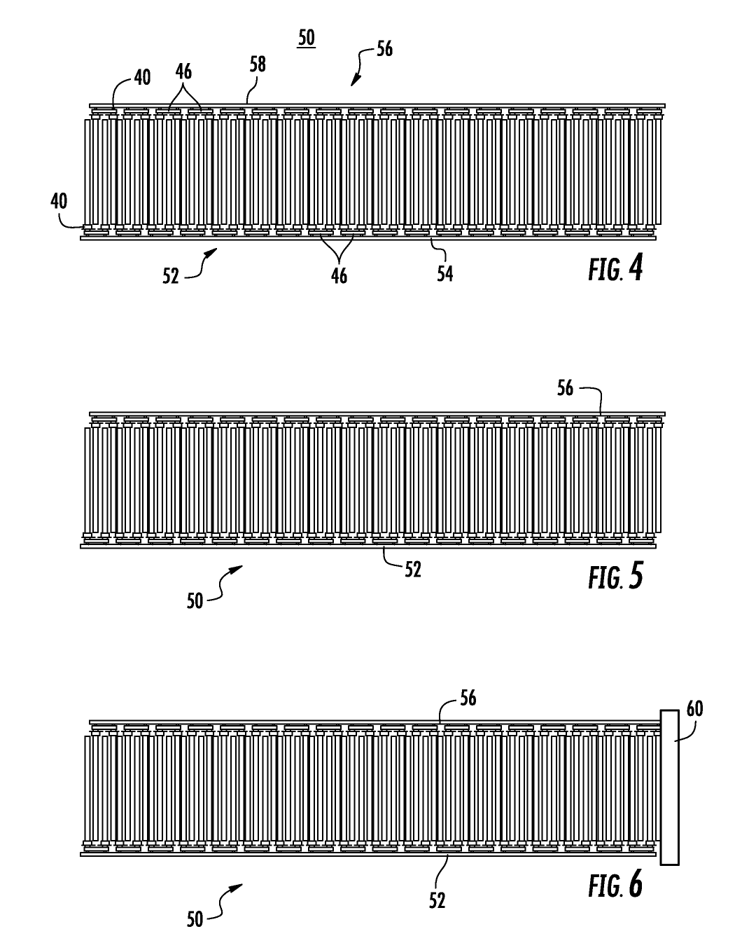

Referring additionally to FIG. 5, torsion bar assembly 50 is mounted so that a torque input applied at the left lower end to gear 44 of the first torsion bar pack 40 in first plurality 52 of torsion bar packs 40 is transferred straight across the assembly to the right lower end at gear 45 of the last torsion bar pack 40 in first plurality 52. Similarly, a torque input applied at the left upper end to gear 44 of the first torsion bar pack 40 in second plurality 56 of torsion bar packs 40 is transferred straight across the assembly to the right upper end at gear 45 of the last torsion bar pack 40 in second plurality 56.

Referring additionally to FIG. 6, torsion bar assembly 50 is mounted as described in conjunction with FIG. 4 and in addition a torque transfer linkage 60 is attached to the right end (in FIG. 6) so that torque applied to the input at the upper left corner of second plurality 56 appears as an output at the right upper corner of second plurality 56 and is transferred as an input to the right lower corner of first plurality 52 and appears as the total output of torsion bar assembly 50 at the left lower corner of first plurality 52. That is a torque input applied at the left upper end to gear 44 of the first torsion bar pack 40 in second plurality 56 of torsion bar packs 40 is transferred straight across the assembly to the right upper end at gear 45 of the last torsion bar pack 40 in second plurality 52. Gear 45 at the right upper end is coupled to gear 45 at the right lower end of the first torsion bar pack 40 in first plurality 52 of torsion bar packs 40 by torque transfer linkage 60. The torque input applied at the right lower end to gear 45 of the last torsion bar pack 40 in first plurality 52 of torsion bar packs 40 is transferred straight across the assembly to the left lower end at gear 44 of the first torsion bar pack 40 in first plurality 52. Thus, all of torsion bars 42 and 43 in both the first plurality 52 and the second plurality 56 are connected in series to increase the angular deflection while maintaining the same maximum torque as an individual spring.

Thus, the torsion bar pack and the torsion bar assembly are ways of combining individual tubular torsion bars together to manipulate performance characteristics. The torsion bar pack combines tubular torsion bars together in series or in parallel in an energy storage module. The packs or modules can then be combined together in series and/or parallel to manufacture extremely large assemblies for high capacity energy storage applications. It will be understood that large assemblies can include any combination of series and/or parallel tubular torsion bars to provide the desired characteristics. The large assemblies increase the energy storage capacity while maintaining a single input/output interface, several of which might be included. In the series connection the tubular torsion bars are combined in an assembly that increases the angular deflection while maintaining the same maximum torque as an individual spring. In the parallel connection the tubular torsion bars are combined in an assembly that increases the maximum torque while maintaining the same angular deflection as an individual spring. In a combination of series and parallel connections of tubular torsion bars increases of the maximum torque and the angular deflection could be achieved.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A torsion bar pack comprising:
a plurality of torsion bars, each torsion bar of the plurality of torsion bars including at least an elongated inner tube of flexible material having a proximal end and a distal end, an elongated outer tube of flexible material having a proximal end and a distal end, a joiner bushing fixedly attached to the distal end of the inner tube and to the distal end of the outer tube with the inner tube and outer tube positioned in coaxial and concentric nesting positions; and
two or more torsion bars of the plurality of torsion bars connected in one of a torsion bar pack parallel connection or a torsion bar pack series connection.

2. A torsion bar pack as claimed in claim 1 wherein the two or more torsion bars of the plurality of torsion bars are connected at the proximal ends in one of the torsion bar pack parallel connection or the torsion bar pack series connection and the torsion bar pack parallel connection or the torsion bar pack series connection includes input/output apparatus coupled to the proximal ends of the two or more torsion bars.

3. A torsion bar pack as claimed in claim 1 wherein each torsion bar of the plurality of torsion bars includes one elongated inner tube and one elongated outer tube.

4. A torsion bar pack as claimed in claim 1 wherein the elongated inner tube has an inner diameter at or approaching zero.

5. A torsion bar pack as claimed in claim 1 wherein the torsion bar pack parallel connection includes a common mounting element fixed to one of the proximal ends of the inner tubes of the two or more torsion bars and the outer tubes of the two or more torsion bars, the common mounting element fixing the proximal ends of the inner tubes or the outer tubes to prevent rotary movement, and two gears, one each attached to the other of the proximal end of the outer tube or the inner tube of each of the two or more torsion bars, the common mounting element positioning the two or more torsion bars with the two gears meshed for common mirrored rotation, whereby the two or more torsion bars are connected in parallel and an input torque applied to one of the two gears is mirrored in the other of the two gears.

6. A torsion bar pack as claimed in claim 5 wherein the common mounting element fixes the proximal ends of the inner tubes and the two gears, one each, are attached to the proximal ends of the outer tubes.

7. A torsion bar pack as claimed in claim 5 wherein the two or more torsion bars connected in parallel are further connected so that equal torque is applied to each of the two or more torsion bars, whereby the maximum torque in the two or more torsion bars is similar and the maximum torque in the torsion bar pack is doubled.

8. A torsion bar pack as claimed in claim 5 wherein the two gears are further constructed to receive an input torque on one of the gears and provide an output torque on the other of the two gears.

9. A torsion bar pack as claimed in claim 1 wherein the torsion bar pack series connection includes a common mounting element positioning the two or more torsion bars in a parallel spaced apart relationship with one of the proximal ends of the inner tubes of the two or more torsion bars or the proximal ends of the outer tubes of the two or more torsion bars mounted for full floating movement, and two gears, one each of the two gears attached to the proximal end of the other of the outer tube of each of the two or more torsion bars or the inner tube of the two or more torsion bars, and the parallel spaced apart relationship being sufficient to prevent the two gears from meshing, and an interconnection element coupling rotation of the one of the inner tubes of two or more torsion bars or the outer tubes of the two or more torsion bars mounted for full floating movement together, whereby the two or more torsion bars are connected in series.

10. A torsion bar pack as claimed in claim 9 wherein the interconnection element includes one of a belt or a chain.

11. A torsion bar pack as claimed in claim 9 wherein one of the two gears is connected to receive input torque and the other of the two gears is connected to provide output torque.

12. A torsion bar pack as claimed in claim 9 wherein the common mounting element is constructed to mount the proximal ends of the inner tubes of each of the two or more torsion bars for full floating movement and the two gears, one each, are attached to the proximal ends of the outer tubes of each of the two or more torsion bars.

13. A torsion bar assembly including a plurality of torsion bar packs as claimed in claim 1 wherein the plurality of torsion bar packs are coupled together to form at least one input designed to receive input torque and one output designed to provide output torque.

14. A torsion bar assembly including a plurality of torsion bar packs as claimed in claim 1 wherein the plurality of torsion bar packs are coupled together to form two or more inputs, each input being designed to receive a separate input torque, and two or more outputs, each output being designed to provide a separate output torque.

15. A torsion bar assembly comprising:
a plurality of torsion bars, each torsion bar of the plurality of torsion bars including at least an elongated inner tube of flexible material having a proximal end and a distal end, an elongated outer tube of flexible material having a proximal end and a distal end, a joiner bushing fixedly attached to the distal end of the inner tube and to the distal end of the outer tube with the inner tube and outer tube positioned in coaxial and concentric nesting positions;
a common elongated mounting element mounting one end of each of the plurality of torsion bars in one of a torsion bar pack parallel connection or a torsion bar pack series connection so that the torsion bars of each of the plurality of torsion bars extend in a common direction, parallel and spaced apart along the length of the common elongated mounting element; and
each of the plurality of torsion bars having input and output gears coupled therein with gears of adjacent torsion bars meshed together so that the input of each torsion bar pack along the elongated mounting element is connected to the output of the adjacent torsion bar pack, except for end packs.

16. A torsion bar assembly as claimed in claim 15 wherein the plurality of torsion bar packs are coupled together to form at least one input designed to receive input torque and one output designed to provide output torque.

17. A torsion bar assembly as claimed in claim 15 wherein the plurality of torsion bar packs are coupled together to form two or more inputs, each input being designed to receive a separate input torque and two or more outputs, each output being designed to provide a separate output torque.

18. A torsion bar assembly as claimed in claim 15 wherein the plurality of torsion bars are each connected in the torsion bar pack parallel connection, the torsion bar pack parallel connection including a common mounting element fixed to one of the proximal ends of the inner tubes of the two or more torsion bars and the outer tubes of the two or more torsion bars, the common mounting element fixing the proximal ends of the inner tubes or the outer tubes to prevent rotary movement, and two gears, one each attached to the other of the proximal end of the outer tube or the inner tube of each of the two or more torsion bars, the common mounting element positioning the two or more torsion bars with the two gears meshed for common mirrored rotation, whereby the two or more torsion bars are connected in parallel and an input torque applied to one of the two gears is mirrored in the other of the two gears.

19. A torsion bar assembly as claimed in claim 18 wherein the common elongated mounting element fixes the proximal ends of the inner tubes and the two gears, one each, are attached to the proximal ends of the outer tubes.

20. A torsion bar assembly as claimed in claim 19 wherein the two gears are further constructed to receive an input torque on one of the gears and provide an output torque on the other of the two gears.

21. A torsion bar assembly as claimed in claim 15 wherein the plurality of torsion bars are each connected in the torsion bar pack series connection, the torsion bar pack series connection including a common mounting element positioning the two or more torsion bars in a parallel spaced apart relationship with one of the proximal ends of the inner tubes of the two or more torsion bars or the proximal ends of the outer tubes of the two or more torsion bars mounted for full floating movement, and two gears, one each of the two gears attached to the proximal end of the other of the outer tube of each of the two or more torsion bars or the inner tube of the two or more torsion bars, and the parallel spaced apart relationship being sufficient to prevent the two gears from meshing, and an interconnection element coupling rotation of the one of the inner tubes of two or more torsion bars or the outer tubes of the two or more torsion bars mounted for full floating movement together, whereby the two or more torsion bars are connected in series.

22. A torsion bar assembly as claimed in claim 21 wherein the interconnection element includes one of belt or a chain.

23. A torsion bar assembly as claimed in claim 21 wherein one of the two gears is connected to receive input torque and the other of the two gears is connected to provide output torque.

24. A torsion bar assembly as claimed in claim 21 wherein the common elongated mounting element is constructed to mount the proximal ends of the inner tubes of each of the two or more torsion bars for full floating movement and the two gears, one each, are attached to the proximal ends of the outer tubes of each of the two or more torsion bars.
